(19) United States
(12) Patent Application Publication
(10) Pub. No.: US 2021/0278962 A1
(43) Pub. Date: Sep. 9, 2021

(54) OPERATION INPUT DEVICE, CONTROL DEVICE, NON-TRANSITORY STORAGE MEDIUM

(71) Applicant: KABUSHIKI KAISHA TOKAI RIKA DENKI SEISAKUSHO, Aichi (JP)

(72) Inventors: Shuri ARAKAWA, Aichi (JP); Haruhiko HASHIMOTO, Novi, MI (US); Alan YEE, Wolverine Lake, MI (US); Eric DERNAY, Farmington Hills, MI (US)

(73) Assignee: KABUSHIKI KAISHA TOKAI RIKA DENKI SEISAKUSHO, Aichi (JP)

(21) Appl. No.: 17/192,128

(22) Filed: Mar. 4, 2021

Related U.S. Application Data
(60) Provisional application No. 62/985,442, filed on Mar. 5, 2020.

(51) Int. Cl. G06F 3/0484; G06F 3/044; G06F 3/02; G06T 7/50

(52) U.S. Cl. CPC G06F 3/04847; G06T 7/50; G06F 3/02; G06F 3/044

(57) ABSTRACT

There is provided an operation input device comprising: an operation section configured to detect an operation performed by a user; a display section configured to display visual information; and a control section configured to identify a control target device serving as a control target on a basis of the operation performed by the user on the operation section, and control a function of the control target device, wherein the control section causes the display section to display an indicator related to a hierarchical structure including a plurality of layers, each of which is configured to be associated with at least one control target device, and the indicator includes information indicating a selected layer in the hierarchical structure, and information indicating execution states of respective functions of the control target devices associated with the layers.

### CROSS REFERENCE TO RELATED APPLICATION(S)

This application is based upon and claims benefit of priority from U.S. Provisional Patent Application No. 62/985,442, filed on Mar. 5, 2020, the entire contents of which are incorporated herein by reference.

### BACKGROUND

The present invention relates to an operation input device, a control device, and a non-transitory storage medium.

In recent years, devices of performing operations related to a plurality of functions have been developed. For example, WO 2018-066269 A1 discloses an operation device including four independent toggle switches.

However, each of the four toggle switches of the operation device disclosed in WO 2018-066269 A1 is fixedly associated with a single function. In the case of such a configuration, the number of switches increases with increase in the number of functions, which serve as operation targets. Therefore, the device tends to get larger in size with the increase in the number of functions.

### SUMMARY

To solve the above described problem, according to an aspect of the present invention, there is provided an operation input device comprising: an operation section configured to detect an operation performed by a user; a display section configured to display visual information; and a control section configured to identify a control target device serving as a control target on a basis of the operation performed by the user on the operation section, and control a function of the control target device, wherein the control section causes the display section to display an indicator related to a hierarchical structure including a plurality of layers, each of which is configured to be associated with at least one control target device, and the indicator includes information indicating a selected layer in the hierarchical structure, and information indicating execution states of respective functions of the control target devices associated with the layers.

To solve the above described problem, according to another aspect of the present invention, there is provided a control device comprising: a control section configured to identify a control target device serving as a control target among a plurality of control target devices on a basis of an operation performed by a user on an operation section, and control a function of the control target device, wherein the control section causes a display section to display an indicator related to a hierarchical structure including a plurality of layers, each of which is configured to be associated with at least one control target device, and the indicator includes information indicating a selected layer in the hierarchical structure, and information indicating execution states of respective functions of the control target devices associated with the layers.

To solve the above described problem, according to another aspect of the present invention, there is provided a non-transitory storage medium having a program stored therein, the program causing a computer to achieve a control function of identifying a control target device serving as a control target among a plurality of control target devices on a basis of an operation performed by a user on an operation section, and controlling a function of the control target device, wherein the control function causes a display section to display an indicator related to a hierarchical structure including a plurality of layers, each of which is configured to be associated with at least one control target device, and the indicator includes information indicating a selected layer in the hierarchical structure, and information indicating execution states of respective functions of the control target devices associated with the layers.

### BRIEF DESCRIPTION OF THE DRAWINGS

FIG. 1 is a block diagram illustrating a configuration example of a system 1 according to an embodiment of the present invention.

FIG. 2 is a diagram for describing an operation input device 10 that controls functions of control target devices 20 according to the embodiment.

FIG. 3 is a diagram for describing the operation input device 10 that controls functions of the control target devices 20 according to the embodiment.

FIG. 4 is a diagram illustrating an example in which function images 122 are automatically set depending on the control target devices 20 according to the embodiment.

FIG. 5 is a diagram illustrating an example in which function images 122 are automatically set depending on the control target devices 20 according to the embodiment.

FIG. 6A is a diagram illustrating an example in which a function image 122 is manually set according to the embodiment.

FIG. 6B is a diagram illustrating an example in which a function image 122 is manually set according to the embodiment.

FIG. 7A is a diagram illustrating an example in which association among the control target devices 20, columns, and layers in a hierarchical structure is manually changed according to the embodiment.

FIG. 7B is a diagram illustrating an example in which association among the control target devices 20, columns, and layers in the hierarchical structure is manually changed according to the embodiment.

FIG. 8 is a diagram illustrating an example of display control performed to manually change association among the control target devices 20, columns, and layers according to the embodiment.

FIG. 9 is a diagram for describing an example of arranging an operation section 110 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

<<1.1. System Configuration Example>>

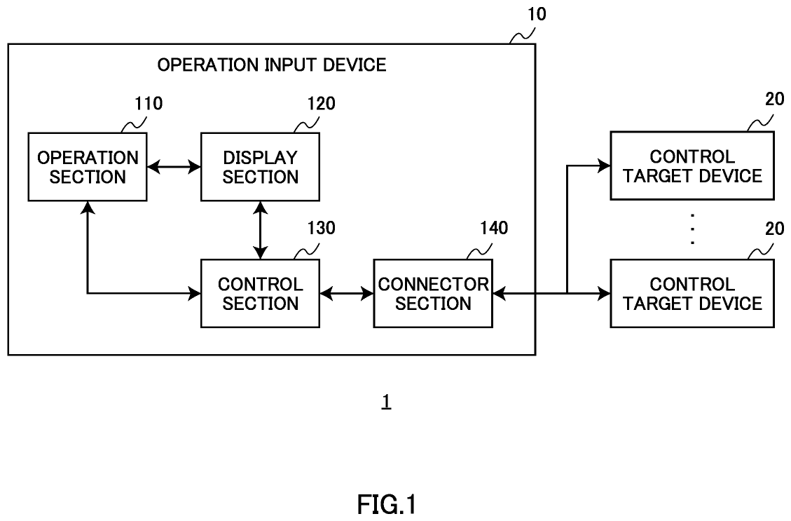

First, a configuration example of a system 1 according to an embodiment of the present invention will be described. FIG. 1 is a block diagram illustrating the configuration example of the system 1 according to the embodiment of the present invention. As illustrated in FIG. 1, the system 1 according to the present embodiment includes an operation input device 10 and a plurality of control target devices 20.

(Operation Input Device 10)

The operation input device 10 according to the present embodiment is a device of receiving an operation performed by a user and controlling a function in response to the operation. In particular, the operation input device 10 according to the present embodiment controls execution of a function of a control target device 20 connected to the operation input device 10. The operation input device 10 according to the present embodiment is widely applicable to a situation where it is assumed to operate a plurality of functions. Examples of the situation include a situation where operations are performed on various kinds of functions (such as an air conditioner, a light, and an audio device) in a vehicle interior of a mobile object. Therefore, for example, the operation input device 10 according to the present embodiment may be installed at a position that allows an occupant (user) who is sitting on a seat to operate the operation input device 10 in the vehicle interior of the mobile object. However, the application of the operation input device 10 according to the present embodiment is not limited thereto. For example, the operation input device 10 according to the present embodiment may be used for operating various kinds of functions related to a home theater (such as a reproduction device, a display device, and an audio device).

As illustrated in FIG. 1, the operation input device 10 according to the present embodiment includes an operation section 110, a display section 120, a control section 130, and a connector section 140.

((Operation Section 110))

The operation section 110 according to the present embodiment detects operations performed by a user. Therefore, the operation section 110 includes various kinds of switches, dials, or the like. The operation section 110 inputs information related to the detected operation performed by the user, to the control section 130.

((Display Section 120))

The display section 120 according to the present embodiment displays various kinds of visual information under the control of the control section 130. For example, the display section 120 may display an image or the like that allows the user to perform an operation related to a desired function. For this reason, the display section 120 includes various kinds of displays.

((Control Section 130))

The control section 130 according to the present embodiment identifies a control target device 20 serving as a control target on the basis of the operation performed by the user on the operation section 110, and controls a function of the identified control target device 20. Details of the function of the control section 130 according to the present embodiment will be described later. Note that, for example, the function of the control section 130 is implemented by a processor such as a graphics processing unit (GPU).

((Connector Section 140))

The connector section 140 according to the present embodiment connects the control section 130 to the control target devices. For example, the connector section 140 includes combinations of a relay, a fuse, and the like. The number of combinations corresponds to the number of the connectable control target devices.

(Control Target Device 20)

The control target device 20 according to the present embodiment may be various kinds of devices that gets connected to the operation input device 10 and executes some kind of function under the control of the operation input device 10. For example, in the case where the system 1 is applied to the mobile object such as a vehicle, examples of the control target device 20 include the light, the audio device, and the air conditioner.

In addition, the control target device 20 according to the present embodiment may be a device that is freely attached to and removed from the operation input device 10 by the user. For example, in the case of the vehicle, sometimes the user may replace a part that has been installed since the delivery of the vehicle with another part that meets preference of the user, or sometimes the user may add a new part. In this case, the control target device 20 serving as a replacement for the pre-installed part and the newly installed control target device 20 get connected to the operation input device 10. This allows the user to operate these control target devices 20 via the operation input device 10.

The configuration example of the system 1 according to the present embodiment has been described above. Note that, the configuration described above with reference to FIG. 1 is a mere example. The configuration of the system 1 according to the present embodiment is not limited thereto. The configuration of the system 1 according to the present embodiment may be flexibly modified in accordance with specifications and operations.

<<1.2. Details of Function>>

Next, functions of the operation input device 10 according to the present embodiment will be described in detail. As described above, in recent years, the devices of performing operations related to a plurality of independent functions have been developed. By using such a device, it is possible to aggregate interfaces for operating the respective functions and improve convenience for the users.

On the other hand, in the case where a single switch is fixedly associated with a single function as disclosed in WO 2018-066269 A1, the number of switches should be the same as the number of functions to be operated. Therefore, if many functions are operated by using a single operation input device, the operation input device gets larger in size with the increase in the number of functions, which are operation targets.

In addition, in this case, it is probably difficult for the user to remember which switch corresponds to which function among the many switches. Therefore, it may be considered that an illustration or text representing a corresponding function is attached to the switch itself. However, in the case where the user replaces a pre-installed part or adds a new part as described in the example of the vehicle, cumbersome processes are necessary.

The technical idea according to the present invention was conceived by focusing on the above-described points, and makes it possible to improve operability of the plurality of functions while avoiding the device from getting larger in size.

Next, features of the operation input device 20 that achieves the above-described effects will be described in detail. Note that, hereinafter, a case where the operation input device 20 according to the present embodiment is installed in the vehicle interior of the mobile object will be described as an example. In addition, hereinafter, the light, the audio device, and the air conditioner attached to the mobile object are considered as examples of the control target device 20.

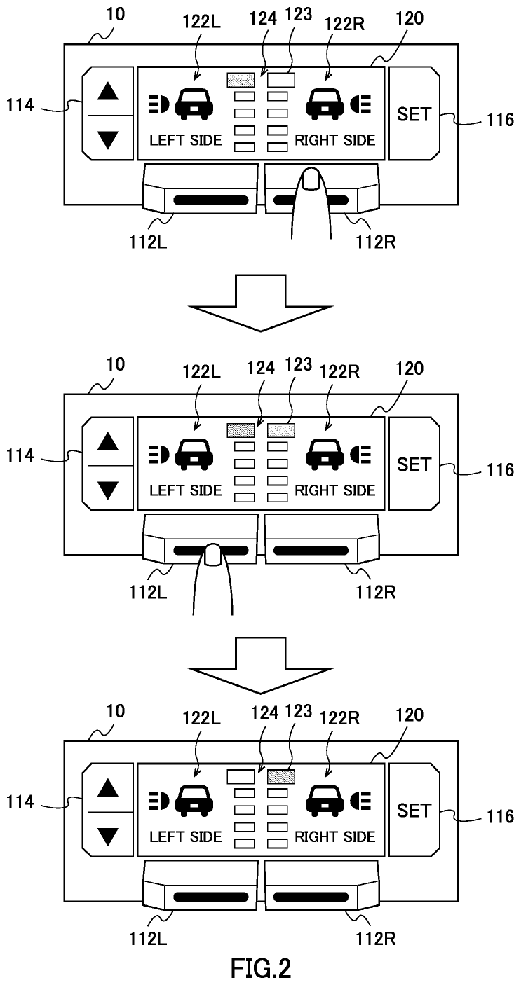

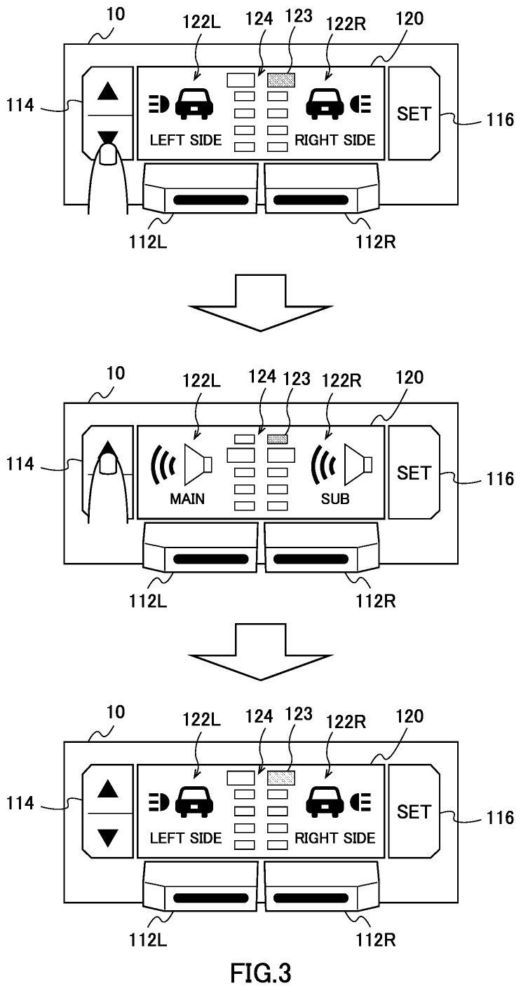

FIG. 2 and FIG. 3 are diagrams for describing the operation input device 10 that controls functions of the control target devices 20 according to the present embodiment. First, description will be given with reference to FIG. 2. FIG. 2 illustrates an example of appearance of the operation input device 20 according to the present embodiment and examples of displayed contents that change on the basis of operations performed by the user.

To operate the plurality of control target devices 20 by using a relatively smaller number of structural parts, the control section 130 of the operation input device 10 according to the present embodiment manages the plurality of control target devices 20 by using a hierarchical structure including a plurality of layers. Each of the layers included in the hierarchical structure can be associated with at least one of the control target devices 20. In addition, one of features of the control section 130 according to the present embodiment is to display an indicator 124 related to the hierarchical structure on the display section 120.

For example, the indicator 124 according to the present embodiment may be represented by a plurality of cells 123 arranged in m number of rows and n number of columns. In this case, the value of m may correspond to the number of layers included in the hierarchical structure, and the value of n may correspond to the number of control target devices 20 that can be associated with the layers. For example, it is assumed that the hierarchical structure includes 5 layers and each of the layers can be associated with two of the control target devices 20. In this case, for example, as illustrated in FIG. 2, the control section 130 may cause the display section 120 to display an indicator 124 including 10 cells 123 arranged in 5 row and 2 columns. In other words, the cells 123 correspond to the respective control target devices 20 (functions of the control target devices 20) associated with the layers.

In addition, the indicator 124 according to the present embodiment may include information indicating a selected layer in the hierarchical structure. For example, the top of FIG. 2 exemplifies a state where a layer (hereinafter, referred to as a first layer) in the first row from the top of the hierarchical structure is selected. In this case, the control section 130 may display two cells 123 in the first row from the top of the indicator 124 in such a manner that the two cells 123 are magnified more than cells 123 in the other rows. This makes it possible to let the user to know that the first layer is selected. By displaying the cells 123 as described above, it is possible for the user to intuitively recognize which layer is selected in the hierarchical structure.

In addition, the control section 130 according to the present embodiment may cause the display section 120 to display function images 122 corresponding to the respective control target devices 20 associated with currently selected layers. For example, it is assumed that the first column from the left of the first layer is associated with a control target device 20, which is a light attached to the left side of the mobile object, and the second column from the left of the first layer is associated with a control target device 20, which is a light attached to the right side of the mobile object. In this case, as illustrated in the top of FIG. 2, the control section 130 may display a function image 122L indicating the light attached to the left side of the mobile object, on the left side of a display region of the display section 120, and the control section 130 may display a function image 122R indicating the light attached to the right side of the mobile object, on the right side of the display region. Such a display allows the user to intuitively recognize the control target devices 20 associated with the selected layer.

In addition, the indicator 124 according to the present embodiment may include information indicating execution states of respective functions of the control target devices 20 associated with the layers. Examples of the information indicating execution states include information indicating whether the function is executed or stopped. For example, in the case where the function of the control target device 20 is executed, the control section 130 may control the display section 120 in such a manner that display of the cell 123 associated with the control target device 20 is more emphasized than a cell 123 associated with a control target device 20 whose function is stopped.

For example, in the case of the example illustrated in the top of FIG. 2, only the control target device 20 associated with the first column of the first layer is under execution among the control target devices 20. Therefore, the control section 130 causes the display section 120 to display the cell 123 in the first row and the first column of the indicator 124 in such a manner that the cell 123 is emphasized by using a dotted pattern, and display the other cells 123 by filling them with white. Such a display allows the user to recognize the execution states of the respective functions of the control target devices 20 associated with the layers at once without switching the displayed layer.

Next, with reference to FIG. 2, operation of the functions of the control target devices 20 according to the present embodiment will be described. The operation section 110 according to the present embodiment may include a function operation section 112 to be used for operating the function of the control target device 20 associated with the selected layer. In this case, the user may instruct to switch between execution and stop of the functions of the respective control target devices 20 associated with the selected layer, by operating the function operation sections 112. In addition, the control section 130 identifies a control target device 20 serving as a control target on the basis of an operation performed by the user on the function operation section 112, and controls a function of the identified control target device 20.

For example, the number of the function operation sections 112 included in the operation section 110 according to the present embodiment may be the same as the number of the control target devices 20 that can be associated with the layers. In this case, the control section 130 according to the present embodiment may identify a control target device 20 associated with the function operation section 112 operated by the user, as the control target device 20 serving as the control target among the control target devices 20 associated with the selected layer.

In the case of the example illustrated in FIG. 2, the operation section 110 includes two function operation sections 112L and 112R, which is the same as the number of the control target devices that can be associated with the layers. Here, the function operation section 112L corresponds to the control target device 20 associated with the first column (left side) of the selected layer, and the function operation section 112R corresponds to the control target device 20 associated with the second column (right side) of the selected layer. Note that, the function operation sections 112L and 112R may be toggle switches that are movable in a vertical direction.

For example, as described above, the top of FIG. 2 illustrates a situation where the first layer of the hierarchical structure is selected, and only the function of the control target device 20 associated with the first column is executed among the two control target devices 20 associated with the first layer.

Here, in the case where the user performs an operation on the function operation section 112R as illustrated in the top of FIG. 2, the control section 130 identifies the control target device 20 corresponding to the function operation section 112R, that is, the control target device 20 that is associated with the second column of the first layer and that is the light attached to the right side of the mobile object, as the control target device 20 serving as the control target on the basis of the operation performed on the function operation section 112R. In addition, for example, the control Section 130 may switch on the light attached to the right side of the mobile object on the basis of an operation performed by the user in such a manner that the function operation section 112R is pushed downward.

In addition, the control section 130 performs control to switch on the light attached to the right side of the mobile object and performs control to emphasize display of the cell 123 in the first row and the second column of the indicator 124 as illustrated in the middle of FIG. 2. Under such control, it is possible for the user to recognize that the light attached to the right side of the mobile object is switched on through the operation performed by himself/herself.

In addition, in the case where the user performs an operation on the function operation section 112L in the above-described state as illustrated in the middle of FIG. 2, the control section 130 identifies the control target device 20 corresponding to the function operation section 112L, that is, the control target device 20 that is associated with the first column of the first layer and that is the light attached to the left side of the mobile object, as the control target device 20 serving as the control target on the basis of the operation performed on the function operation section 112L. In addition, for example, the control Section 130 may switch off the light attached to the right side of the mobile object on the basis of an operation performed by the user in such a manner that the function operation section 112L is pushed upward.

In addition, the control section 130 performs control to switch off the light attached to the left side of the mobile object and performs control to cancel the emphasized display of the cell 123 in the first row and the first column of the indicator 124 as illustrated in the bottom of FIG. 2. Under such control, it is possible for the user to recognize that the light attached to the left side of the mobile object is switched off through the operation performed by himself/herself.

As described above, the function operation section 112 according to the present embodiment may be configured to enter one of at least two states in response to an operation performed by the user such as the operation of pushing the function operation section 112 downward and the operation of pushing the function operation section 112 upward. In this case, the control section 130 according to the present embodiment may control whether to execute or stop the function of the control target device 20 serving as the control target, in accordance with the state of the function operation section 112, which has been changed through the operation performed by the user as described above.

Note that, the two states that the function operation sections 112 may enter are not limited to the above-described examples. For example, the function operation sections 112 according to the present embodiment may be a push-button switch that may enter an un-pushed state and a pushed state. In this case, the control section 130 may perform control to execute the function of the control target device 20 serving as the control target when the function operation section 112 changes from the un-pushed state to the pushed state, and the control section 130 may perform control to stop the function of the control target device 20 serving as the control target when the function operation section 112 changes from the pushed state to the un-pushed state.

Next, with reference to FIG. 3, an operation of selecting a layer according to the present embodiment will be described. The operation section 110 according to the present embodiment may further include a layer selection section 114 that is used for selecting a layer in the hierarchical structure. For example, the layer selection section 114 according to the present embodiment may be a toggle switch that is movable in the vertical direction. In this case, the control section 130 according to the present embodiment may put any of the layers in the hierarchical structure into a selected state on the basis of an operation performed by the user on the layer selection section 114.

For example, the top of FIG. 3 illustrates a situation where the first layer of the hierarchical structure is selected. Here, in the case where the user operates the layer selection section 114 downward only once as illustrated in the top of FIG. 3, the control section 130 puts a layer (hereinafter, referred to as a second layer) in the second row from the top of the hierarchical structure into the selected state as illustrated in the middle of FIG. 3.

In addition, in this case, the control section 130 causes the display section 120 to display function images 122 corresponding to respective control target devices 20 associated with the second layer, which have newly entered into the selected state. Here, it is assumed that the first column of the second layer is associated with a control target device 20, which is a main speaker attached to the mobile object, and the second column of the second layer is associated with a control target device 20, which is a sub speaker attached to the mobile object. In this case, as illustrated in the middle of FIG. 3, the control section 130 displays a function image 122L indicating the main speaker, on the left side of the display region of the display section 120, and the control section 130 displays a function image 122R indicating the sub speaker, on the right side of the display region.

On the other hand, in the case where the user operates the layer selection section 114 upward only once as illustrated in the middle of FIG. 3, the control section 130 may put the layer into the selected state as illustrated in the bottom of FIG. 3. In addition, at this time, the control section 130 performs control in such a manner that the function images 122L and 122R changes into the function images 122L and 122R indicating the respective control target devices 20 associated with the first column and the second column of the first layer.

As described above, it is possible for the user to select ant layer in the hierarchical structure by using the layer selection section 114 according to the present embodiment. Subsequently, it is possible to operate the functions of the control target devices 20 associated with the selected layer as illustrated in FIG. 2.

Note that, the layer selection section 114 according to the present embodiment is not limited to the toggle switch. The layer selection section 114 according to the present embodiment may have various kinds of forms. For example, the layer selection section 114 according to the present embodiment may be a dial switch, a slide switch, or the like. In this case, the control section 130 may put a layer into the selected state in accordance with a direction and quantity of operating the layer selection section 114. In addition, for example, the layer selection section 114 according to the present embodiment may be the push-button switch. In this case, the control section 130 may sequentially changes a layer to be enter the selected state each time the layer selection section 114 is pushed.

Next, an example of setting the function images 122 according to the present embodiment will be described. As described above, the function images according to the present embodiment may be images indicating the respective control target devices 20 associated with the selected layer, which are images to be used by the user to identify a control target device 20 serving as the operation target. The control section 130 according to the present embodiment may have a function of automatically setting the function images 122 depending on the control target devices 20.

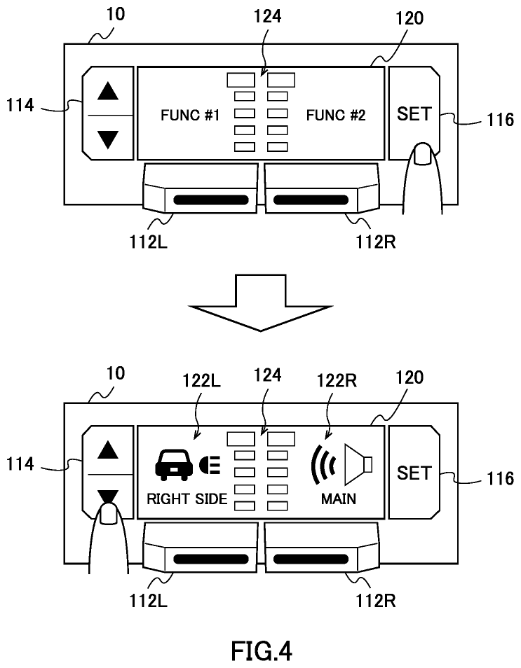

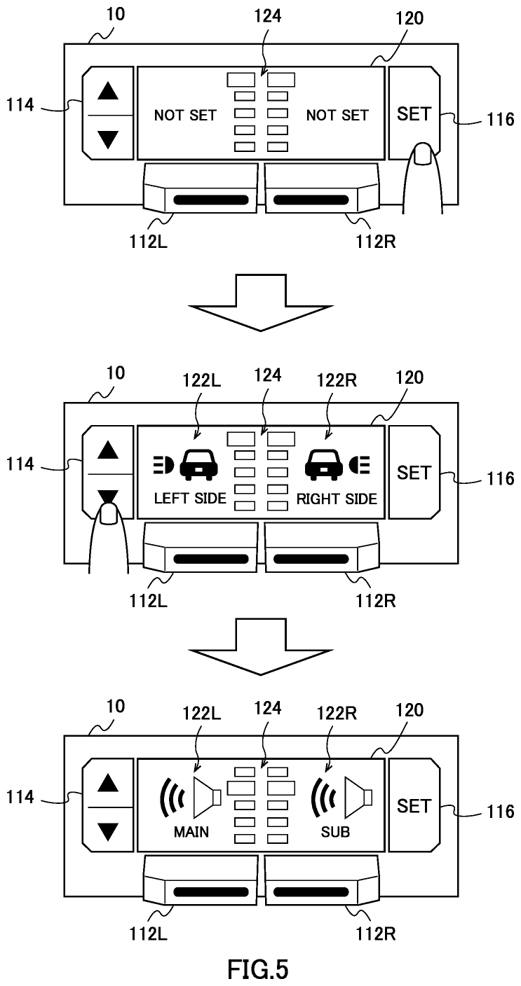

FIG. 4 and FIG. 5 are diagrams illustrating an example in which function images 122 are automatically set depending on the control target devices 20 according to the present embodiment. First, an example illustrated in FIG. 4 will be described. The top of FIG. 4 illustrates a state where no function image 122 is set for the first column or the second column of the first layer. In addition, the operation section 100 according to the present embodiment further includes an image setting section 116 configured to be used for an operation of setting the function image. For example, the image setting section 116 may be a push-button switch.

When the user operates the image setting section 116 in this state, the control section 130 acquires function information from control target devices 20 connected to respective relays corresponding to the first column and the second column of the first layer among relays included in the connector section 140, and sets function images 122 depending on the respective control target devices 20. Note that, the function information according to the present embodiment may be information indicating functional characteristics of the control target devices 20. Examples of the function information include classification of the function of the control target device 20, a product name of the control target device 20, the model number of the control target device 20, and the like.

For example, in the case of the example illustrated in the bottom of FIG. 4, the control section 130 determines that a control target device 20 connected to a relay of the connector section 140 corresponding to the first column of the first layer is the light attached to the right side of the mobile object on the basis of function information acquired from the control target device 20, and sets a function image 122L corresponding to the light for the first column of the first layer.

In a similar way, the control section 130 determines that a control target device 20 connected to a relay of the connector section 140 corresponding to the second column of the first layer is the main speaker attached to the vehicle interior on the basis of function information acquired from the control target device 20, and sets a function image 122L corresponding to the main speaker for the second column of the first layer.

As described above, by using the control section 130 according to the present embodiment, it possible to automatically set the function image 122 on the basis of the function information acquired from the control target device 20, and it is also possible to reduce the user's burden of configuring the settings.

Note that, the above description is the example of automatically setting the function images 122 in the case where the relays of the connector section 140 are fixedly associated with respective combinations of a column and layer defined in the hierarchical structure.

However, the control section 130 may dynamically change the association between the relays and the combinations of the layer and the column according to the present embodiment. In addition, in this case, the control section 130 may associate a plurality of the control target devices 20, which are related to each other, with a same layer on the basis of the function information.

The top of FIG. 5 illustrates a state where no function image 20 is associated with the first column or the second column of the first layer.

When the user operates the image setting section 116 in this state, the control section 130 acquires function information from control target devices 20 connected to respective relays of the connector section 140. Next, the control section 130 tries to detect a combination of control target devices 20 whose functions are related to each other, on the basis of the acquired function information from among the plurality of control target devices 20. Here, in the case where the combination of the control target devices 20 whose functions are related to each other is detected, the control section 130 associates the control target devices 20 with the layers and sets the function images 122 on the basis of the detected combination of the control target devices 20.

For example, in the case of the example illustrated in the middle of FIG. 5, the control section 130 detects a combination of control target devices 20 having functions related to lights on the basis of acquired function information, and associates the combination with the first layer.

Alternatively, for example, in the case of the example illustrated in the bottom of FIG. 5, the control section 130 detects a combination of control target devices 20 having functions related to speakers on the basis of acquired function information, and associates the combination with the second layer.

As described above, the control section 130 according to the present embodiment makes it possible to automatically associate the plurality of control target devices 20 having functions related to each other with a same layer. This allows the user to easily find a desired function.

Note that, the examples illustrated in FIG. 4 and FIG. 5 are the cases where the function images 122 are set and the control target devices 20 are associated in response to the operations performed by the user on the image setting section 116. However, the user does not have to operate the image setting section 116 to execute the above-described functions. For example, the function may be automatically executed at a timing of activating the operation input device 10 after the control target devices 20 are connected to the connector section 140.

On the other hand, it is also considered that some users want to set the function images 122 and associate the control target devices 20 with layers and columns in accordance with their preference. Therefore, the system 1 may be designed in a way that allows the user to manually set the function images 122 and manually associate the control target devices 20.

For example, the control section 130 according to the present embodiment may set a function image selected by the user for the control target device 20 associated with the selected layer, on the basis of an operation performed by the user on the operation section 10.

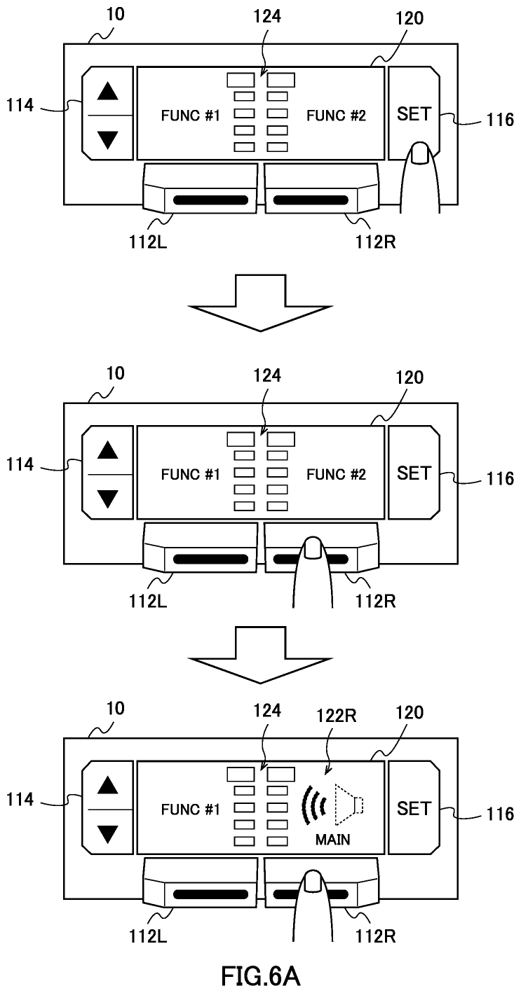

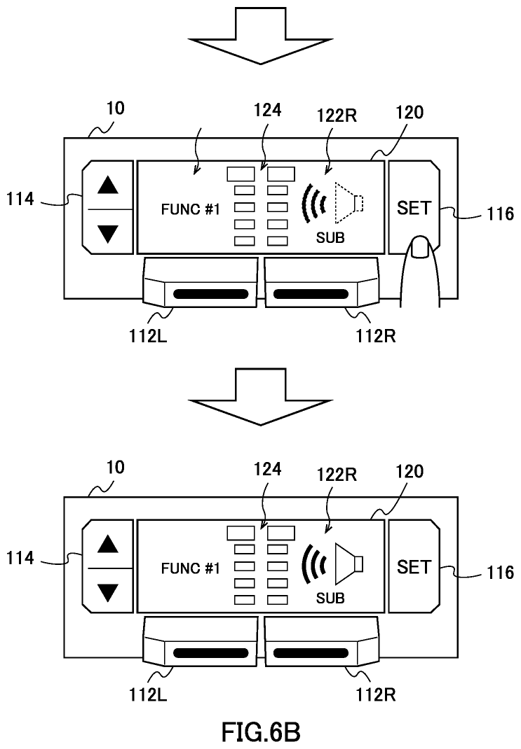

FIG. 6A and FIG. 6B are diagrams illustrating an example in which a function image 122 is manually set according to the present embodiment. The top of FIG. 6A illustrates a state where no function image 122 is set for the first column or the second column of the first layer. When the user operates the image setting section 116 in this state, the control section 130 transitions to a mode in which the user sets the function image 122.

Next, the control section 130 identifies a control target device 20 serving as a target of setting the function image 122 on the basis of the function operation section 112 operated by the user. For example, in the case where the user operates the function operation section 112R as illustrated in the middle of FIG. 6A, the control section 130 identifies the control target device 20 associated with the second column of the first layer as the target.

Next, as illustrated in the bottom of FIG. 6, the control section 130 cases the display section 120 to display a candidate for the function image 122R to be set for the control target device 20 associated with the second column of the first layer. At this time, the control section 130 may perform control in such a manner that the display of the function image 122R is blinking.

In the case where the user further operates the function operation section 112R in this situation, the control section 130 cases the display section 120 to display another candidate for the function image 122R to be set for the control target device 20 associated with the second column of the first layer in a blinking manner as illustrated in the top of FIG. 6B.

Here, in the case where the user operates the image setting section 116 as illustrated in the top of FIG. 6B, the control section 130 cancels the blinking display of the function image 122R as illustrated in the bottom of FIG. 6, and sets the function image 122R for the control target device 20 associated with the second column of the first layer.

As described above, the control section 130 according to the present embodiment may set the function image 122 selected by the user for the control target device 20 associated with the selected layer, on the basis of the series of operations performed by the user beginning with the operation performed on the image setting section 116. Under such control, it is possible to customize the function image 122 in accordance with the user's preference.

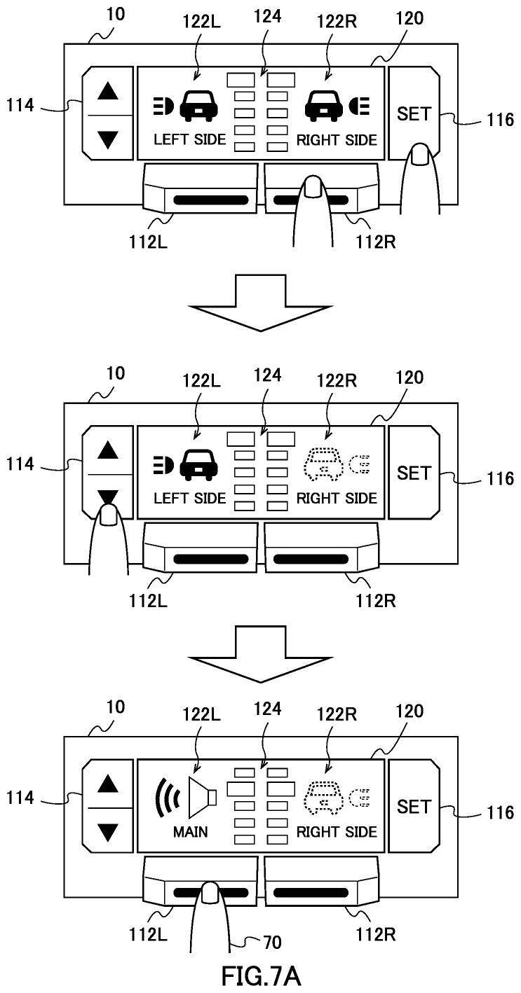

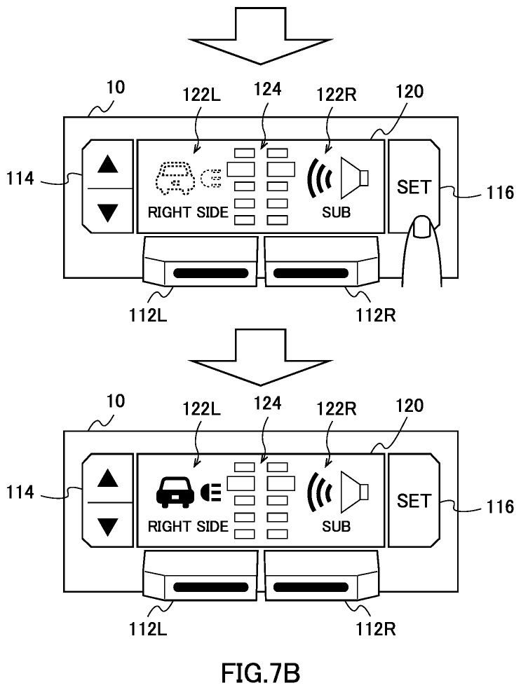

Next, a description will be provided with regard to an example in which association among the control target devices 20, columns, and layers in the hierarchical structure is manually changed. FIG. 7A and FIG. 7B are diagrams illustrating examples in which association among the control target devices 20, columns, and layers in the hierarchical structure is manually changed according to the present embodiment.

The top of FIG. 7A illustrates a situation where the first column of the first layer is associated with a control target device 20, which is the light attached to the left side of the mobile object, and the second column of the first layer is associated with a control target device 20, which is the light attached to the right side of the mobile object.

Here, when a predetermined operation performed by the user is detected, the control section 130 transitions to a mode of resetting the association among the control target devices 20, the columns, and the layers. Examples of the predetermined operation include simultaneous operations performed on the image setting section 116 and the function operation section 112.

For example, when the user operates the function operation section 112 while pressing the image setting section 116 as illustrated in the top of FIG. 7A, the control section 130 transitions to the mode of resetting the association among the column, the layer, and the control target device 20 that is the light attached to the right side of the mobile object. In this case, as illustrated in the middle of FIG. 7A, the control section 130 may display the function image 122R indicating the light attached to the right side of the mobile object in the blinking manner. This makes it possible to show the user that the mode has transitioned into the resetting mode.

When the user operates the layer selection section 114 in this situation, the control section 130 selects a layer in accordance with a content of the operation. For example, in the case where the user operates the layer selection section 114 downward once as illustrated in the middle of FIG. 7A, the control section 130 selects the second layer while maintaining the display of the function image 122R indicating the light attached to the right side of the mobile object as illustrated in the bottom of FIG. 7A.

In addition, in the case where the user operates the function operation section 112, the control section 130 moves the blinking display of the function image 122 to a position of a column corresponding to the operated function operation section 112. For example, in the case where the function operation section 112L is operated as illustrated in the bottom of FIG. 7A, the control section 130 displays the function image 122L indicating the light attached to the right side of the mobile object, in the blinking manner on the left side of the display region of the display section 120, and the control section 130 displays the function image 122R corresponding to the control target device 20, which has been originally associated with the second column of the second layer , on the right side of the display region.

After the operation is performed as illustrated in the top of FIG. 7B, the control section 130 cancels the blinking display of the function image 122L as illustrated in the bottom of FIG. 7B, and newly stores the control target device 20 that is the light attached to the right side of the mobile object, in associated with the first column of the second layer. Note that, in this case, the control target device 20 that has been originally associated with the first column of the second layer may be newly associated with the second column of the first layer.

The example in which the association among the control target devices 20, columns, and layers is manually changed according to the present embodiment has been described above. Under such control, it is possible for the user to freely change the association among the control target devices 20, the columns, and the layers in accordance with the user's preference.

However, the displays illustrated in FIG. 7A and FIG. 7B are mere examples. The control over display according to the present embodiment is not limited thereto.

For example, FIG. 7A and FIG. 7B illustrate the case of achieving blinking display of the function image 122 selected by the user to change the position of the function image 122 in the indicator 124.

By using such blinking display, it is possible for the user to intuitively recognize the function image 122 serving as a target to be changed, and it is possible to prevent the function image 122 corresponding to the control target device 20 from being changed erroneously and unintentionally.

However, in the case of displaying the selected function image 122 in the blinking manner, there is a moment when no function image 122 is displayed on the display section 120.

Therefore, it is assumed that a time period during which the user looks at the display section 120 increases.

In view of the aforementioned issue, it is also possible for the control section 130 according to the present embodiment to control display in such a manner that the time period during which the user looks at the display section 120 decreases more.

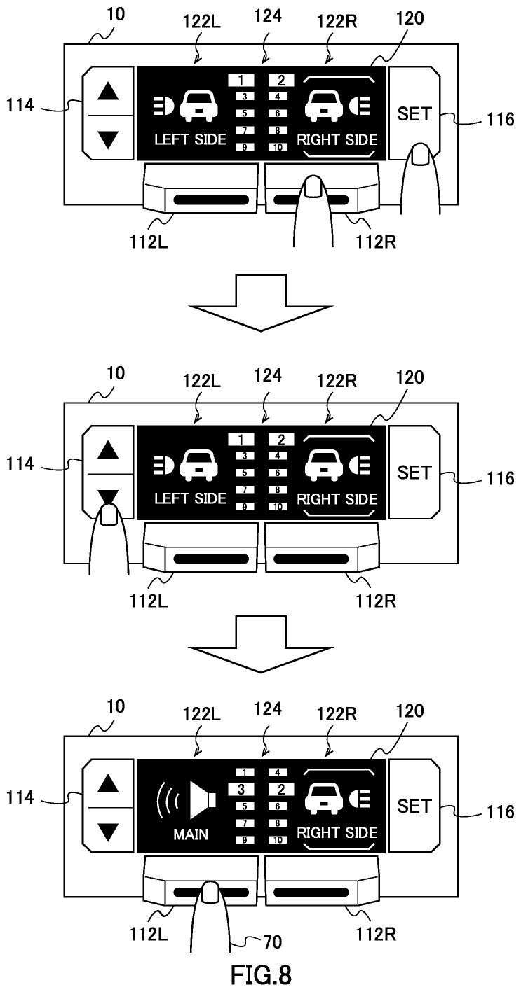

FIG. 8 is a diagram illustrating an example of display control performed to manually change association among the control target devices 20, columns, and layers according to the present embodiment.

In a way similar to the situation illustrated in the top of FIG. 7A, the top of FIG. 8 illustrates a situation where the mode is transitioned into the mode of resetting the association among the control target devices 20, the columns, and the layers through the operation performed by the user.

At this time, the control section 130 according to the present embodiment may control the display section 120 in such a manner that the function images 122 and the like are expressed differently between the resetting mode and a normal mode of operating a function.

For example, in the case of an example illustrated in FIG. 8, the control section 130 according to the present embodiment performs control in such a manner that display of the bright and dark regions of the function images 122 in the normal mode is reverse of display of the bright and dark regions of the function images 122 in the resetting mode.

Under such control, it is possible for the user to intuitively recognize that the normal mode is transitioned into the resetting mode.

For example, this makes it possible to prevent the user from perform an operation without noticing the transition of mode in the case where the user has touched the image setting section 116 unintentionally and the normal mode has been transitioned into the resetting mode, for example.

Note that, the reverse of display of the bright and dark regions illustrated in FIG. 8 is a mere example. The control over display of transition of mode according to the present embodiment is not limited thereto.

For example, the transition of mode according to the present embodiment may be expressed by change in contrast, color, effect, or the like.

In addition to the control over display related to the above-described transition of mode, the control section 130 according to the present embodiment may control display in such a manner that the function image 122 selected through an operation performed by the user is emphasized.

For example, in the case of the example illustrated in FIG. 8, the control section 130 according to the present embodiment controls the display section 120 in such a manner that a boxed function image 122R is displayed in response to an operation performed by the user on the function operation section 112R.

At this time, the control section 130 does not have to blink the function image 122R unlike the example illustrated in FIG. 7A and FIG. 7B.

Under such control, it is possible for the user to intuitively recognize the selected function image 122R. In addition, by always displaying the function image 122R, it is possible to reduce the time period during which the user looks at the display section 120.

Next, with reference to FIG. 8 again, control over display related to association between the control target devices 20 and the indicator 124 according to the present embodiment will be described.

In the example illustrated in FIG. 8, the cells 123 of the indicator 124 are displayed in association with numbers unlike the examples illustrated in FIG. 2 to FIG. 7B.

The numbers may correspond to the respective control target devices 20 connected to the connector section 140.

For example, it is assumed that the numbers “1” to “10” are assigned to respective relays of the connector section 140.

Here, for example, in the case where the first column of the first layer is associated with the control target device 20 connected to the relay to which the number “1” is assigned, the control section 130 performs control in such a manner that the cell 123 corresponding to the first column of the first layer is displayed in association with the number “1”.

In addition, for example, in the case where the second column of the first layer is associated with the control target device 20 connected to the relay to which the number “2” is assigned, the control section 130 performs control in such a manner that the cell 123 corresponding to the second column of the first layer is displayed in association with the number “2”.

The control section 130 may control display of the other cells 123 in similar ways.

In the case of controlling the display as described above, it is assumed that the user operates the layer selection section 114 downward in a state where the function image 122R is selected as illustrated in the middle of FIG. 8.

Here, the function image 122R illustrated in the middle of FIG. 8 may be an image corresponding to the control target device 20 connected to the relay to which the number “2” is assigned (the light attached to the right side of the mobile object).

In this case, as illustrated in the bottom of FIG. 8, the control section selects the second layer while maintaining the display of the function image 122R corresponding to the control target device 20, and the control section 130 changes the number associated with the cell 123 corresponding to the second column of the second layer to the number “2”.

Under such control, it is possible for the user to continuously recognize which control target device 20 is associated with which cell 123 even in the case where the user has changed the association between the cell 123 and the number.

This makes it possible to prevent the user from detaching the control target device 20 erroneously and unintentionally, in the case of replacing the control target device 20 connected to the relay of the connector 140, for example.

Note that, the case where the numbers indicate association between the cells 123 and the control target devices 20 connected to the relay has been exemplified above, the association may be indicated by alphabets, marks, colors, or the like.

The detailed example of controlling display according to the present embodiment has been described above. As described above, the control performed by the control section 130 according to the present embodiment over the display can be flexibly modified.

Next, an example of arranging the operation section 110 included in the operation input device 10 according to the present embodiment will be described.

As described above, the operation section 110 according to the present embodiment may include the function operation sections 112, the layer selection section 114, and the image setting section 116.

For example, FIG. 2 to FIG. 8 illustrate the case where the layer selection section 114 is arranged on the left side of the display section 120. However, this arrangement is a mere example.

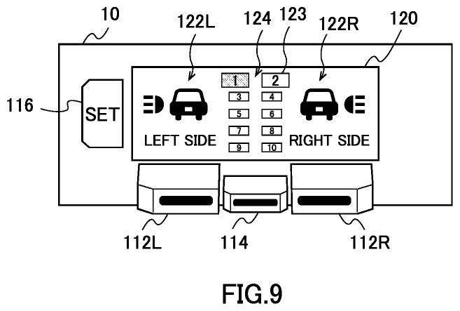

FIG. 9 is a diagram for describing an example of arranging the operation section 110 according to the present embodiment.

For example, the layer selection section 114 according to the present embodiment may be arranged on a line extended from an axis representing a depth direction of the hierarchical structure of the indicator 124.

In the case of the example illustrated in FIG. 9, the indicator 124 displays the first layer to a fifth layer in the vertical direction of the display section 120. In this case, the axis representing the depth direction of the hierarchical structure is a vertical axis of the display section 120.

Therefore, as illustrated in FIG. 9, the layer selection section 114 may be arranged below the display position of the indicator 124 along the vertical axis.

Such arrangement allows the user to intuitively associate the layer selection section 114 with the depth direction of the hierarchical structure of the indicator 124 and intuitively performs operations.

In addition, as illustrated in FIG. 9, in the case where the layer selection section 114 is arranged in parallel to the function operation section 112L and the function operation section 112R, efficiency of operation is expected to be improved by aggregating the structural elements to be operated by the user in the normal mode.

On the other hand, for example, in the case of performing an operation in the normal mode without looking at the display section 120, the is a possibility that the user erroneously operates the function operation section 112 instead of the layer selection section 114, and vice versa.

In view of the aforementioned issue, the layer selection section 114 and the function operation section 112 according to the present embodiment may have different external shapes from each other.

The external shape includes shape, size, type of switch (such as the toggle switch or the push-button switch), and the like.

In the case of the example illustrated in FIG. 9, the layer selection section 114 and the function operation section 112 have different shapes and sizes from each other.

Such a difference in external shape makes it possible to effectively reduce a possibility that the user confuses the layer selection section 114 with the function operation sections 112.

Note that, to emphasize the difference between the layer selection section 114 and the function operation section 112, the layer selection section 114 and the function operation section 112 may provide different senses of touch when being operated by the user.

Next, an example of arranging the image setting section 116 according to the present embodiment will be described. Unlike the layer selection section 114 and the function operation sections 112, the image setting section 116 according to the present embodiment is not used in the normal mode.

Therefore, as illustrated in FIG. 9, the image setting section 116 according to the present embodiment may be arranged at a position relatively distant from the layer selection section 114 and the function operation sections 112.

Such arrangement makes it possible to effectively reduce prevent the user from erroneous operations.

In addition, to further improve the effect of preventing erroneous operations, the image setting section 116 according to the present embodiment may have a different external shape from the layer selection section 114 and the function operation sections 112.

In addition, the image setting section 116 according to the present embodiment may be arranged depending on a positional relation between the operation input device 10 and a steering wheel installed in the mobile object.

For example, it is assumed that the operation input device 10 is arranged on the left side or the right side of the steering wheel at a relatively close distance from the steering wheel.

In this case, there is a possibility that a partial region enters a blind spot of the user. The partial region is close to the steering wheel and is on an operation surface of the operation input device 10.

Therefore, for example, in the case where the operation input device 10 is arranged on the left side of the steering wheel, the image setting section 116 may be arranged in a region on the left side of the operation surface as illustrated in FIG. 9, in such a manner that the image setting section 116 is unlikely to enter the blind spot of the user.

The example of arranging the operation section 110 according to the present embodiment has been described above. As described above with reference to FIG. 9, the arrangement of the operation section 110 according to the present embodiment can be flexibly modified.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In the above- described embodiment the example in which the operation input device 10 is used for controlling various kinds of functions related to the mobile object has been descried as a major example, However, the range of application of the operation input device 10 is not limited to such an example. For example, the operation input device 10 may be implemented as a remote control for controlling functions of a plurality of home appliances in standard households. In this case, the home appliances serving as the respective control target devices 20 may be connected to the operation target device 10 through wireless communication.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into RAM, and executed by a processor such as a CPU. The recording medium may be a magnetic disk, an optical disc, a magneto-optical disc, flash memory, or the like, for example. Alternatively, the above-described computer program may be distributed via a network without using the recording medium, for example.

What is claimed is:

1. An operation input device comprising:
an operation section configured to detect an operation performed by a user;
a display section configured to display visual information; and
a control section configured to identify a control target device serving as a control target on a basis of the operation performed by the user on the operation section, and control a function of the control target device,
wherein the control section causes the display section to display an indicator related to a hierarchical structure including a plurality of layers, each of which is configured to be associated with at least one control target device, and
the indicator includes information indicating a selected layer in the hierarchical structure, and information indicating execution states of respective functions of the control target devices associated with the layers.

2. The operation input device according to claim 1, wherein
the operation section includes at least a layer selection section configured to be used for selecting a layer in the hierarchical structure, and a function operation section configured to be used for operating the function of the target control device associated with the selected layer, and
the control section selects any of the layers in the hierarchical structure on a basis of an operation performed by the user on the layer selection section, identifies the control target device serving as the control target on a basis of the operation performed by the user on the function operation section, and controls the function of the operation target device.

3. The operation input device according to claim 2, wherein
the number of the function operation sections included in the operation section is same as the number of the control target devices configured to be associated with the layers, and
the control section identifies a control target device corresponding to the function operation section operated by the user, as the control target among the control target devices associated with selected layer.

4. The operation input device according to claim 2, wherein
the function operation section is configured to enter one of at least two states in response to an operation performed by the user, and
the control section controls whether to execute or stop the function of the control target device serving as the control target, in accordance with the state of the function operation section, which has been changed by the operation performed by the user.

5. The operation input device according to claim 1,
wherein the control section causes the display section to display function images corresponding to the respective control target devices associated with selected layer.

6. The operation input device according to claim 5, further comprising
a connector section configured to connect the control section to the control target device, which is removable.

7. The operation input device according to claim 6,
wherein the control section acquires function information indicating a functional characteristic of the control target device from the control target device connected to the connector section, and sets the function image corresponding to the control target device on a basis of the function information.

8. The operation input device according to claim 6,
wherein the control section acquires function information indicating functional characteristics of the control target devices from the control target devices connected to the connector section, and associates the plurality of control target devices, which are related to each other, with a same layer on a basis of the function information.

9. The operation input device according to claim 6,
wherein the control section sets the function image selected by the user for the control target device associated with the selected layer, on a basis of an operation performed by the user on the operation section.

10. The operation input device according to claim 9, wherein
the operation section further includes an image setting section configured to be used for an operation of setting the function image, and
the control section sets the function image selected by the user for the control target device associated with the selected layer, on a basis of a series of operations beginning with an operation performed on the image setting section.

11. The operation input device according to claim 2,
wherein the layer selection section is arranged on a line extended from an axis representing a depth direction of the hierarchical structure of the indicator.

12. The operation input device according to claim 11,
wherein the layer selection section and the function operation section have different external shapes from each other.

13. The operation input device according to claim 1,
wherein the operation input device is configured to be arranged at a position that allows a user who is sitting on a seat to operate the operation input device, in a vehicle interior of a mobile object.

14. A control device comprising:
a control section configured to identify a control target device serving as a control target among a plurality of control target devices on a basis of an operation performed by a user on an operation section, and control a function of the control target device,
wherein the control section causes a display section to display an indicator related to a hierarchical structure including a plurality of layers, each of which is configured to be associated with at least one control target device, and
the indicator includes information indicating a selected layer in the hierarchical structure, and information indicating execution states of respective functions of the control target devices associated with the layers.

15. A non-transitory storage medium having a program stored therein, the program causing a computer to achieve
a control function of identifying a control target device serving as a control target among a plurality of control target devices on a basis of an operation performed by a user on an operation section, and controlling a function of the control target device,
wherein the control function causes a display section to display an indicator related to a hierarchical structure including a plurality of layers, each of which is configured to be associated with at least one control target device, and
the indicator includes information indicating a selected layer in the hierarchical structure, and information indicating execution states of respective functions of the control target devices associated with the layers.
